(19) United States
(12) Patent Application Publication
(10) Pub. No.: US 2009/0018019 A1
(43) Pub. Date: Jan. 15, 2009

(54) INCREASING PATHOGEN DEFENCE IN PLANTS

(76) Inventors: Wolfgang Thielert, Odenthal (DE); Wolfram Andersch, Bergisch Gladbach (DE); Peter Eckes, Kelkheim (DE); Jurgen Benting, Leichlingen (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 12/067,545

(22) PCT Filed: Sep. 19, 2006
(86) PCT No.: PCT/EP06/09072

§ 371 Date: Aug. 7, 2008

(30) Foreign Application Priority Data
Sep. 21, 2005 (DE) 10 2005 045 174.8

(51) Int. Cl. A01N 43/50; A01P 21/00; A01P 3/00; A01P 1/00

(52) U.S. Cl. 504/253; 514/341

(57) ABSTRACT

A method of increasing the inherent defense mechanisms of plants by treating them with chloronicotinyls is disclosed. Chloronicotinyls produce, independently of their control of insects, effective protection of plants against damage from fungal, bacterial or viral pathogens. This defense against pathogens is obtained by the induction of PR proteins resulting from treatment with at least one chloronicotinyl.

The present invention relates to a method of increasing the defence of plants against pathogens.

It is known that plants react to natural stress conditions, such as for example cold, heat, dryness, wounding and pathogenic infections (caused by viruses, bacteria, fungi or insects) etc. as well as to herbicides by specific or non-specific defence mechanisms [cf. Pflanzenbiochemie (Plant Biochemistry), pp. 393-462, Spektrum Akademischer Verlag, Heidelberg, Berlin, Oxford, Hans W Heldt, 1996; Biochemistry and Molecular Biology of Plants, pp. 1102-1203, American Society of Plant Physiologists, Rockville, Md., eds. Buchanan, Gruissem, Jones, 2000]. In this process cell wall components formed for example by wounding or specific pathogen-derived signal substances act as inducers of plant signal transduction chains which in the end lead to the formation of defence molecules directed against the stress factor. These substances can for example be (a) low molecular weight substances, such as for example phytoalexins, (b) non-enzymatic proteins, such as for example “pathogenesis-related proteins” (PR proteins), (c) enzymatic proteins, such as for example chitinases or glucanases or (d) specific inhibitors of essential proteins, such as for example protease inhibitors or xylanase inhibitors, which attack the pathogen directly or hinder its proliferation (cf. Dangl and Jones, 2001, Nature 411: 826-833; Kessler and Baldwin, 2003, Annual Review of Plant Biology, 53: 299-328).

An additional defence mechanism is the so-called hypersensitive reaction (HR) which is induced by oxidative stress and leads to the dying-off of plant tissue in the region of the site of an infection, thus preventing the spread of plant pathogens, which need living cells to survive [cf. Pennazio, 1995, New Microbiol. 18, pp. 229-240].

In the further course of an infection, the plant's inherent messenger substances send signals to non-affected tissue, in which they also cause defensive responses to be triggered and hinder the formation of secondary infections (System Acquired Resistance, SAR) [Ryals et al., 1996, The Plant Cell 8: 1809-1819].

A number of plant-endogenous signal substances are already known which are involved in stress tolerance or pathogen defence. These include for example salicylic acid, benzoic acid, jasmonic acid or ethylene [Biochemistry and Molecular Biology of Plants, pp. 850-929, American Society of Plant Physiologists, Rockville, Md., eds. Buchanan, Gruissem, Jones, 2000]. Some of these substances or their stable synthetic derivatives and derived structures are also effective when applied externally to plants or seed dressings and they activate defence reactions which produce increased stress or pathogen tolerance by plants [Sembdner and Parthier, 1993, Ann. Rev. Plant Physiol. Plant Mol. Biol. 44: 569-589]. This salicylate-induced defence is directed specifically against phytopathogenic fungi, bacteria and viruses [Ryals et al., 1996, The Plant Cell 8: 1809-1819].

One well-known synthetic product which has a similar function to salicylic acid and can induce a protective effect against phytopathogenic fungi, bacteria and viruses, is benzothiadiazole (trade name Bion®) [Achuo et al., 2004, Plant Pathology 53 (1): 65-72].

Other compounds belonging to the oxylipin group, such as for example jasmonic acid, and the protective mechanisms triggered thereby are particularly effective against insect pests [Walling, 2000, J Plant Growth Regul. 19, 195-216].

It is therefore known that plants have several endogenous reaction mechanisms which can produce effective defence against the most diverse types of harmful organisms (biotic stress) and/or natural abiotic stress.

It is already known that chloronicotinyl insecticides can be used for combating animal pests, and in particular insects. It is also known that the treatment of plants with insecticides from the chloronicotinyl series produces increased resistance of plants to abiotic stress. This applies in particular to imidacloprid (cf. Brown et al., 2004, Beltwide Cotton Conference Proceedings: 2231-2237). This protection functions by influencing the physiological and biochemical properties of the plant cells, such as for example by improving membrane stability, increasing the carbohydrate concentration and increasing the polyol concentration and antioxidant activity (Gonias et al., 2004, Beltwide Cotton Conference Proceedings: 2225-2229).

Only occasional references can be found in the literature to the activity of chloronicotinyls against biotic stress factors (Crop Protection (2000), 19(5), 349-354; Journal of Entomological Science (2002), 37(1), 101-112; Annals of Biology (Hisar, India) (2003), 19(2), 179-181).

Chloronicotinyls can be defined by the following general formula (I),

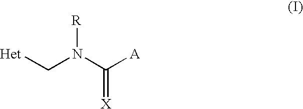

in which
Het represents a heterocycle which is in each case optionally mono- or polysubstituted by fluorine, chlorine, methyl or ethyl and is selected from the following group of heterocycles:
   pyrid-3-yl, pyrid-5-yl, 3-pyridinio, 1-oxido-5-pyridinio, 1-oxido-5-pyridinio, tetrahydro-furan-3-yl and thiazol-5-yl,
A represents C₁-C₆-alkyl, —N(R¹)(R²) or S(R²),
   wherein
   R¹ represents hydrogen, C₁-C₆-alkyl, phenyl-C₁-C₄-alkyl, C₃-C₆-cycloalkyl, C₂-C₆-alkenyl or C₂-C₆-alkinyl and
   R² represents C₁-C₆-alkyl, C₂-C₆-alkenyl, C₂-C₆-alkinyl, —C(═O)—CH₃ or benzyl,
R represents hydrogen, C₁-C₆-alkyl, C₂-C₆-alkenyl, C₂-C₆-alkinyl, —C(═O)—CH₃ or benzyl or, together with R², represents one of the following groups:
   —CH₂—CH₂—, —CH₂—CH₂—CH₂—, —CH₂—O—CH₂—, —CH₂—S—CH₂—, —CH₂—NH—CH₂— and —CH₂—N(CH₃)—CH₂— and
X represents N—NO₂, N—CN or CH—NO₂.
Het particularly preferably represents a heterocycle selected from the following group of heterocycles:
   2-chloropyrid-5-yl, 2-methylpyrid-5-yl, 1-oxido-3-pyridinio, 2-chloro-1-oxido-5-pyridinio, 2,3-dichloro-1-oxido-5-pyridinio, tetrahydrofuran-3-yl, 5-methyl-tetrahydrofuran-3-yl and 2-chlorothiazol-5-yl.
A particularly preferably represents —N(R¹)(R²).
R¹ particularly preferably represents hydrogen, methyl or ethyl.
R² particularly preferably represents methyl, ethyl, n- or i-propyl, n-, i-, s- or t-butyl, ethenyl, 1-propenyl, 2-propenyl, ethinyl, 1-propinyl, 2-propinyl, —C(═O)—CH₃ or benzyl.
R particularly preferably represents hydrogen, methyl, ethyl or —C(═O)—CH₃ or particularly preferably, together with R², represents one of the following groups:
   —CH₂—CH₂—, —CH₂—CH₂—CH₂—, —CH₂—O—CH₂— or —CH₂—S—CH₂—.

This class of compounds includes for example the following list of compounds, which must not however be understood to be final:

imidacloprid of the formula (I)

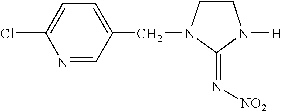

(I), cf. EP 0 192 060,
clothianidine of the formula (II)

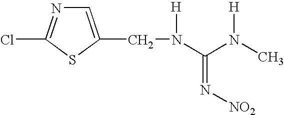

(II), cf. EP 0 376 279,
dinotefuran of the formula (III)

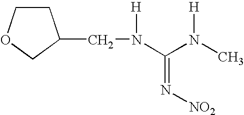

(III), cf. EP 0 649 845,
thiamethoxam of the formula (IV)

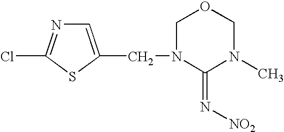

(IV), cf. EP 0 580 553,
thiacloprid of the formula (V)

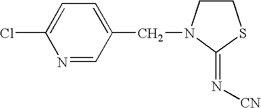

(V), cf. EP 0 235 725,
acetamiprid of the formula (VI)

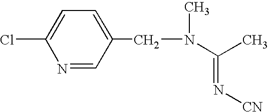

(VI), cf. WO 91/04965 and
nitenpyram of the formula (VII)

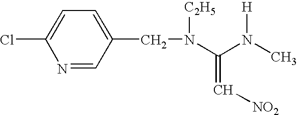

(VII), cf. EP 0 302 389.

Surprisingly it has now been found that chloronicotinyls, and in particular imidacloprid, result in the increased expression of genes from the group comprising “pathogenesis-related proteins” (PR proteins). PR proteins assist plants primarily in their defence against biotic stressors, such as for example phytopathogenic fungi, bacteria and viruses. This means that, after applying imidacloprid, plants are more effectively protected from infections by phytopathogenic fungi, bacteria and viruses. Where it is necessary to use fungicides and bactericides as mixtures with imidacloprid, or where the latter is used sequentially to fungicides and bactericides, their activity is supported thereby.

### DEFINITIONS OF TERMS USED HEREINBELOW

The term “cDNA” (complementary DNA), as used herein, describes a single DNA strand which is synthesized with a sequence complementary to an RNA and in vitro by enzymatic reverse transcription. The cDNA can either correspond to the whole RNA length or represent only a partial sequence of the RNA serving as the matrix.

The terms “DNA chip” and “DNA microarray”, which are used synonymously herein, refer to a matrix, the basic material of which consists, for example, of glass or nylon, onto which DNA fragments are immobilized, it being possible for the application of the DNA to be carried out for example by (a) a photolithographic process (DNA is synthesized directly on the array matrix), (b) a microspotting process (externally synthesized oligonucleotides or PCR products are applied to the matrix and covalently bonded thereto), or (c) by a microspraying process (externally synthesized oligonucleotides or PCR products are sprayed onto the matrix contactlessly by an ink-jet printer) (cf. R. Rauhut, Bioinformatik (Bioinformatics), pp 197-199, ed: Wiley-VCH Verlag GmbH, Weinheim, 2001). A DNA chip, which represents genomic sequences of an organism, is referred to as a “genomic DNA chip”. The analysis of the measured values obtained with the aid of these DNA chips is referred to as “DNA chip analysis”.

The term “DNA chip hybridization”, as used herein, refers to the pairing of two single-strand complementary nucleic acid molecules, one of the base-pairing molecular partners being localized as DNA (deoxyribonucleic acid) on the DNA chip, preferably in a covalently bonded form, whereas the other is present in solution in the form of the RNA (ribonucleic acid) or the cDNA corresponding thereto (complementary DNA). The bound and non-bound nucleic acids are hybridized on the DNA chip in an aqueous buffer solution, optionally under additionally denaturizing conditions, such as for example in the presence of dimethyl sulphoxide, at temperatures of 30-60° C., preferably 40-50° C., and particularly preferably 45° C. for 10-20 hours, preferably 14-18 hours, and particularly preferably 16 hours with constant movement. The hybridization conditions can be kept constant, for example, in a hybridization oven. Under standard conditions movements of 60 rpm (rounds per minute) are obtained in such a hybridization oven.

The terms “expression patterns”, “induction patterns” and “expression profile” used synonymously herein describe the time-differentiated and/or tissue-specific expression of the plant mRNA, this pattern being obtained directly by the intensity of the hybridization signal produced by the RNA obtained from the plant or its corresponding cDNA with the aid of DNA chip technology. The “expression values” measured are obtained by directly offsetting the resulting signals against corresponding signals obtained using a synonymous chip by hybridization with a non-treated control plant.

The term “expression state”, which is obtained by the “gene expression profiling” process, as used herein, describes the whole transcriptional activity recorded for cellular genes and measured with the aid of a DNA chip.

The term “whole RNA”, as used herein, describes the possible representation, due to the digestion process used, of various plant-endogenous RNA groups which can be present in a plant cell, such as for example cytoplasmic rRNA (ribosomal RNA), cytoplasmic tRNA (transfer RNA), cytoplasmic mRNA (messenger RNA), and their respective nuclear precursors ctRNA (chloroplastic RNA) and mtRNA (mitochondrial RNA), although it also includes RNA molecules which can be derived from exogenous organisms, such as for example viruses or parasitic bacteria and fungi.

The term “useful plants”, as used herein, refers to crop plants which are used as plants for obtaining food- or feedstuffs or for technological purposes.

The active compounds can be converted into the customary formulations such as solutions, emulsions, spray powders, water- and oil-based suspensions, powders, dusting agents, pastes, soluble powders, soluble granules, scatter granules, suspension/emulsion concentrates, natural substances impregnated with active compounds, synthetic substances impregnated with active compounds, fertilizers and microencapsulations in polymeric materials.

These formulations are produced in a known manner, for example by mixing the active compounds with extenders, i.e. liquid solvents and/or solid carriers, optionally using surface-active agents, i.e. emulsifying agents and/or dispersants and/or foam-producing agents. The formulations are produced either in suitable machines or before or during use.

Auxiliaries which may be used are substances which are suitable for providing the agent itself and/or preparations derived therefrom (such as spray mixtures or seed dressings) with special properties, such as specific technical properties, and/or also special biological properties. Typical auxiliaries which can be used are: extenders, solvents and carriers.

Suitable extenders are for example water, polar and non-polar organic chemical liquids, for example from the classes comprising aromatic and non-aromatic hydrocarbons (such as paraffins, alkylbenzenes, alkylnaphthalenes and chlorobenzenes), alcohols and polyols (which can optionally also be substituted, etherified and/or esterified), ketones (such as acetone and cyclohexanone), esters (including fats and oils) and (poly-)ethers, simple and substituted amines, amides, lactams (such as N-alkylpyrrolidones) and lactones, sulphones and sulphoxides (such as dimethyl sulphoxide).

Where water is used as an extender organic solvents can for example also be used as cosolvents. Liquid solvents mainly suitable are the following: aromatic compounds such as xylene, toluene or alkylnaphthalenes, chlorinated aromatic compounds and chlorinated aliphatic hydrocarbons such as chlorobenzenes, chloroethylenes or methylene chloride, aliphatic hydrocarbons such as cyclohexane or paraffins, such as for example petroleum fractions, mineral and vegetable oils, alcohols, such as butanol or glycol and ethers and esters thereof, ketones such as acetone, methyl ethyl ketone, methyl isobutyl ketone or cyclohexanone and strongly polar solvents such as dimethyl sulphoxide and water.

Suitable solid carriers are the following:

e.g. ammonium salts and natural rock powders, such as kaolins, clays, talcum, chalk, quartz, attapulgite, montmorillonite or diatomaceous earth and synthetic rock powders such as highly disperse silica, aluminium oxide and silicates; suitable solid carriers for granules are: for example crushed and fractionated natural rocks such as calcite, marble, pumice, sepiolite, dolomite and synthetic granules of inorganic and organic powders and granules of organic materials such as paper, sawdust, coconut shells, corn stalks and tobacco stalks; suitable emulsifiers and/or foam-forming agents are: for example non-ionic and anionic emulsifiers, such as polyoxyethylene fatty acid esters, polyoxyethylene fatty alcohol ethers, for example alkylaryl polyglycol ethers, alkyl sulphonates, alkyl sulphates, aryl sulphonates and protein hydrolyzates; suitable dispersants are non-ionic and/or ionic substances, for example from the classes comprising alcohol POE and/or POP ethers, acid and/or POP or POE esters, alkyl-aryl and/or POP or POE ethers, fatty and/or POP-POE adducts, POE and/or POP polyol derivatives, POE and/or POP/sorbitan or sugar adducts, alkyl or aryl sulphates, sulphonates and phosphates or the corresponding PO ether adducts. Furthermore, suitable oligomers or polymers, for example based on vinyl monomers, acrylic acid, EO and/or PO alone or in combination with for example (poly-)alcohols or (poly-amines. Use can also be made of lignin and sulphonic acid derivatives thereof, simple and modified celluloses, aromatic and/or aliphatic sulphonic acids and adducts thereof with formaldehyde.

It is possible to use in the formulations adhesives such as carboxymethylcellulose, natural and synthetic powdered, granular or latex-like polymers such as gum arabic, polyvinyl alcohol, polyvinyl acetate and natural phospholipids, such as cephalins and lecithins and synthetic phospholipids.

It is possible to use colouring agents such as inorganic pigments, for example iron oxide, titanium oxide, Prussian blue and organic colouring agents such as alizarin, azo and metal phthalocyanine dyes and trace nutrients such as salts of iron, manganese, boron, copper, cobalt, molybdenum and zinc.

Further additives can be odorants, mineral or vegetable, optionally modified, oils, waxes and nutrients (including trace nutrients), such as salts of iron, manganese, boron, copper, cobalt, molybdenum and zinc.

The formulations can also contain stabilizers such as low-temperature stabilizers, preservatives, antioxidants, light-protecting agents or other agents improving chemical and/or physical stability. The formulations generally contain between 0.01 and 98 wt.-% of active compound, preferably between 0.5 and 90%.

The active compound according to the invention can be used in its commercially available formulations and in the use forms prepared from these formulations as mixtures with other active compounds such as insecticides, attractants, sterilants, bactericides, acaricides, nematicides, fungicides, growth-regulating substances, herbicides, safeners, fertilizers or semiochemicals.

The present invention relates to the use of chloronicotinyls to protect plants from fungi, bacteria and viruses. Chloronicotinyls produce, independently of their control of insects, effective protection of plants against damage by fungal, bacterial or viral pathogens.

Advantages over other possible methods are the low application rates for obtaining such protection, the high phytocompatibility and the already existing approvals for the use of chloronicotinyls in agriculture. In addition, a single active compound can be used for protecting plants from a large number of pathogens.

In order to obtain protection from pathogens, the plants can be treated with individual active compounds or with combinations of chloronicotinyls.

In addition, the abovementioned positive effects of chloronicotinyls on the inherent defence mechanisms of plants can be supported by additional treatment with fungicidal or bactericidal active compounds.

In a preferred embodiment this protection is obtained by the induction of PR proteins as a result of treatment with chloronicotinyls.

Preferred chloronicotinyls are imidacloprid, clothianidine, dinotefuran, thiamethoxam, thiacloprid, acetamiprid and nitenpyram. Particularly preferred chloronicotinyls are imidacloprid, thiacloprid, clothianidine and thiamethoxam. Imidacloprid is very particularly preferred.

According to the invention, plants particularly preferably treated are those of the plant varieties in each case commercially available or in use. Plant varieties are understood to be plants with new properties (“traits”), which have been bred both by conventional methods, by mutagenesis or with the aid of recombinant DNA techniques. Crop plants can therefore be plants which can be obtained by conventional breeding and optimization methods or by biotechnological and genetechnological methods or combinations of these methods, including transgenic plants and including plant varieties which are or are not protectable under plant variety laws.

Preferred plants are barley, tobacco, tomatoes, wheat, corn, rice, soya, cotton, rape, potatoes, brassicas, paprika, aubergines, cucumbers, lettuce, melons, turf, citrus, vines, coffee, tea, hops, pomaceous fruit, stone fruit and soft fruit.

Barley is particularly preferred.

The methods according to the invention are particularly also suitable for use on transgenic plants and transgenic seeds. Preferred chloronicotinyls for this use are imidacloprid, clothianidine and thiamethoxam. Imidacloprid is very particularly preferred for this use.

Preferred pathogens are Phytophthora nicotianae, Peronospora tabacinae, Phytophthora infestans, Sphaerotheca fuliginea, Phakopsora pachyrhizi, Ramularia gossypii, Rhizoctonia solani, Curvularia spec., Pyrenophora spec., Sclerotinia homoeocarpa, Erysiphe graminis and Colletotrichum graminicola.

Preferred points in time for the application of chloronicotinyls for defending plants against pathogens are seed, soil, nutrient solution, stem and/or leaf treatments with the approved application rates.

The quantities of a chloronicotinyl for obtaining the properties according to the invention can be varied over a relatively large range. Concentrations of 0.00001% to 0.05%, particularly preferably 0.000025% to 0.025% and very particularly preferably 0.000025% to 0.005%, are preferred for obtaining the inventive effect. If mixtures are used, the concentration of the active compound combinations is preferably between 0.000025% and 0.005%, and particularly preferably between 0.00005% and 0.001%. The indicated values above and below are, unless otherwise specified, percentages by weight.

The following example describes the invention in detail.

### EXAMPLE 1

### The Induction of PR Proteins in Barley after Treatment with Imidacloprid

Barley seeds (of the Baroness variety) were sown in pots containing soil about 2 cm deep (1250 g of sandy loam/per pot; the soil moisture content was adjusted to 70% of the maximum water-holding capacity) and cultivated in a climatized chamber under specified light, moisture and temperature conditions (15 h white light, 70% atmospheric humidity, 23-19° C. day/night).

14 days after the emergence of the barley plants 10 mg of imidacloprid per plant, dissolved in 100 ml water, were applied by means of a pipette to the soil around the base of the shoot. The same volume of water without any active compound was applied to the control pots. After the soil treatment the plants were no longer watered. At various times after application (0.25; 1; 6; 8; 11; 13; 15; 16 and 17 days) the leaves were harvested, quick-frozen in liquid nitrogen and stored at −80° C. until further treatment.

The labelled RNA probes for the DNA chip hybridization were produced according to the protocols (Expression Analysis, Technical Manual) of the Affymetrix company (Affymetrix Inc., 3380 Central Expressway, Santa Clara, Calif., USA). Whole RNA was first of all isolated from in each case 500 mg of the harvested leaves. 10 μg portions of whole RNA were used for the first and second strand cDNA synthesis. The cDNA was amplified with T7 polymerase and simultaneously labelled with biotin-UTP. 20 μg portions of this biotinylated cDNA were used for the hybridization of the barley genome array (Barleyl Gene Chip, Item no: 511012) from Affymetrix. This DNA microarray contains DNA sequences of 22840 genes composed of a total of 400000 EST (Expressed Sequence Tag) sequences. Then the DNA microarrays were washed in the Affymetrix Fluidics Station, stained with streptavidin/phycoerythrin (Molecular Probes, P/N S-866) and scanned with the Affymetrix Gene Chip Scanner 3000. The fluorescence data obtained were analyzed with the Microarray Suite 5 software from Affymetrix and the Expressionist Pro software from the GeneData company. After a quality check, all of the DNA chip analyses were stored in a database. Since the Affymetrix Gene Chip System is based on measuring the absolute expression values of the genes contained in the chip, the expression values of the biological replicates of treated and non-treated plants were averaged after normalization (median calculation). With the aid of the statistical ANOVA method, those genes were identified whose expression was increased in the plants treated with imidacloprid but remained relatively constant in the untreated controls. The assembly of gene groups from specific metabolic pathways, signal transduction chains or functions was carried out by a keyword search through the gene annotations supplied by Affymetrix and by linking the genes to their corresponding Gene Ontology Annotations (Gene Ontology Consortium).

On searching through gene groups from signal transduction chains and metabolic pathways associated with stress tolerance and pathogen defence, a powerful induction of genes for PR proteins was found in treated plants compared with non-treated plants (tables 1-3).

TABLE 1
“Pathogenesis-related protein” genes induced by imidacloprid

| Affy metrix no. | Description of the genes |
|---|---|
| Contig2990_at | CHITINASE (EC 3.2.1.14) |
| Contig2788_x_at | THAUMATIN-LIKE PROTEIN TLP7 |
| Contig2214_s_at | PATHOGENESIS RELATED PROTEIN |
| | (HV-1A) |
| Contig2209_at | PATHOGENESIS RELATED PROTEIN |
| | (HV-1A) |
| Contig639_at | PATHOGENESIS-RELATED PROTEIN |
| | PRECURSOR |
| Contig2210_at | PATHOGENESIS-RELATED PROTEIN 1 |
| | PRECURSOR |
| Contig17082_at | TRYPSIN INHIBITOR |
| Contig2212_s_at | PATHOGENESIS-RELATED PROTEIN |
| | PRB1-3 |
| Contig11773_at | REGULATOR OF PATHOGENICITY |
| | FACTORS |
| Contig12046_at | PATHOGENESIS RELATED PROTEIN-1 |
| Contig4405_x_at | PATHOGENESIS-RELATED PROTEIN |
| | PR-10A |
| HV_CEb0020C01r2_at | INTEGUMENTARY MUCIN B.1 |
| Contig2550_x_at | PATHOGENESIS-RELATED PROTEIN 4 |
| Contig2211_at | PATHOGENESIS-RELATED PROTEIN |
| | PRECURSOR |

TABLE 2
Median of the raw expression data (in each case 3 biological replicates)

| | 0.25 days | | 1 day | | 6 days | | 8 days | | 11 days | |
|---|---|---|---|---|---|---|---|---|---|---|
| Affymetrix no. | treated | treated | treated | treated | treated | treated | treated | treated | untreated | treated |
| Contig2990_at | 35.51 | 31.12 | 31.38 | 29.13 | 66.82 | 561.20 | 43.07 | 830.74 | 49.01 | 664.56 |
| Contig2788_x_at | 90.09 | 71.22 | 47.02 | 70.44 | 445.30 | 5432.88 | 989.41 | 7952.61 | 1940.45 | 12190.31 |
| Contig2214_s_at | 96.03 | 86.29 | 39.68 | 44.68 | 338.95 | 3322.93 | 433.24 | 4807.28 | 479.17 | 4463.75 |
| Contig2209_at | 239.67 | 187.60 | 106.74 | 153.35 | 489.30 | 4773.49 | 711.28 | 8173.99 | 711.11 | 8587.82 |
| Contig639_at | 218.37 | 157.66 | 41.56 | 38.68 | 289.31 | 2482.57 | 269.13 | 3944.01 | 479.62 | 4273.57 |
| Contig2210_at | 241.38 | 143.08 | 61.60 | 78.12 | 866.31 | 6881.20 | 1017.88 | 8961.17 | 1460.36 | 7946.25 |
| Contig17082_at | 173.51 | 161.42 | 182.26 | 162.50 | 197.68 | 745.06 | 230.64 | 853.21 | 250.42 | 911.63 |
| Contig2212_s_at | 165.29 | 153.25 | 137.70 | 135.85 | 363.79 | 3508.08 | 382.89 | 3936.08 | 430.16 | 3866.40 |
| Contig11773_at | 187.82 | 175.49 | 71.90 | 70.99 | 194.41 | 1513.72 | 191.42 | 2102.86 | 212.15 | 1580.30 |
| Contig12046_at | 85.31 | 76.89 | 57.89 | 46.22 | 121.37 | 786.00 | 184.88 | 1336.13 | 101.84 | 792.96 |
| Contig4405_x_at | 57.15 | 60.34 | 55.27 | 55.96 | 68.93 | 146.82 | 64.94 | 181.30 | 56.60 | 125.79 |
| HV_CEb0020C01r2_at | 68.25 | 96.81 | 86.20 | 87.44 | 96.17 | 418.12 | 150.33 | 428.35 | 180.21 | 389.74 |
| Contig2550_x_at | 86.98 | 68.63 | 47.12 | 54.66 | 122.48 | 716.14 | 152.46 | 1121.61 | 126.26 | 771.21 |
| Contig2211_at | 217.60 | 223.31 | 221.83 | 206.49 | 263.78 | 824.50 | 252.07 | 928.65 | 290.17 | 868.02 |

| | | | |
|---|---|---|---|
| 13 days | 15 days | 16 days | 17 days |

| Affymetrix no. | treated | treated | treated | treated | treated | treated | treated | treated |
|---|---|---|---|---|---|---|---|---|
| Contig2990_at | 77.68 | 235.46 | 216.16 | 227.32 | 31.04 | 76.80 | 52.55 | 32.84 |
| Contig2788_x_at | 2083.35 | 4800.62 | 3248.12 | 4880.14 | 721.89 | 1836.52 | 998.31 | 1166.53 |
| Contig2214_s_at | 125.46 | 636.20 | 273.34 | 808.24 | 516.41 | 1241.52 | 756.38 | 472.04 |
| Contig2209_at | 287.59 | 1723.94 | 633.29 | 1689.29 | 823.13 | 2069.04 | 1406.75 | 888.58 |
| Contig639_at | 132.32 | 1496.21 | 322.95 | 920.86 | 298.41 | 1300.36 | 416.44 | 1196.37 |
| Contig2210_at | 426.37 | 1553.93 | 706.30 | 1970.04 | 845.77 | 2013.49 | 1627.64 | 1121.55 |
| Contig17082_at | 126.15 | 281.55 | 137.96 | 209.34 | 174.85 | 276.41 | 208.27 | 225.25 |
| Contig2212_s_at | 126.72 | 470.29 | 167.28 | 378.35 | 316.94 | 756.91 | 531.25 | 376.36 |
| Contig11773_at | 59.01 | 208.99 | 96.55 | 182.27 | 185.22 | 694.71 | 148.57 | 340.39 |
| Contig12046_at | 51.84 | 140.26 | 60.92 | 150.31 | 211.37 | 622.77 | 254.76 | 220.80 |
| Contig4405_x_at | 41.99 | 55.42 | 50.58 | 57.66 | 62.61 | 88.69 | 56.98 | 87.06 |
| HV_CEb0020C01r2_at | 107.82 | 180.00 | 175.74 | 170.35 | 132.88 | 161.77 | 191.56 | 106.72 |
| Contig2550_x_at | 48.92 | 150.42 | 112.63 | 162.60 | 145.82 | 389.62 | 190.59 | 174.42 |
| Contig2211_at | 166.66 | 296.99 | 221.25 | 252.25 | 231.97 | 340.64 | 267.64 | 219.24 |

TABLE 3
Induction factor = Expression (treated)/Expression
(untreated) as a function of the times in days (d).

| Affymetrix no. | 0.25 d | 1 d | 6 d | 8 d | 11 d | 13 d | 15 d | 16 d | 17 d |
|---|---|---|---|---|---|---|---|---|---|
| Contig2990_at | 0.9 | 0.9 | 8.4 | 19.3 | 13.6 | 3.0 | 1.1 | 2.5 | 0.6 |
| Contig2788_x_at | 0.8 | 0.7 | 12.2 | 8.0 | 6.3 | 2.3 | 1.5 | 2.5 | 1.2 |
| Contig2214_s_at | 0.9 | 0.5 | 9.8 | 11.1 | 9.3 | 5.1 | 3.0 | 2.4 | 0.6 |
| Contig2209_at | 0.8 | 0.6 | 9.8 | 11.5 | 12.1 | 6.0 | 2.7 | 2.5 | 0.6 |
| Contig639_at | 0.7 | 0.3 | 8.6 | 14.7 | 8.9 | 11.3 | 2.9 | 4.4 | 2.9 |
| Contig2210_at | 0.6 | 0.4 | 7.9 | 8.8 | 5.4 | 3.6 | 2.8 | 2.4 | 0.7 |
| Contig17082_at | 0.9 | 1.1 | 3.8 | 3.7 | 3.6 | 2.2 | 1.5 | 1.6 | 1.1 |
| Contig2212_s_at | 0.9 | 0.9 | 9.6 | 10.3 | 9.0 | 3.7 | 2.3 | 2.4 | 0.7 |
| Contig11773_at | 0.9 | 0.4 | 7.8 | 11.0 | 7.4 | 3.5 | 1.9 | 3.8 | 2.3 |
| Contig12046_at | 0.9 | 0.8 | 6.5 | 7.2 | 7.8 | 2.7 | 2.5 | 2.9 | 0.9 |
| Contig4405_x_at | 1.1 | 0.9 | 2.1 | 2.8 | 2.2 | 1.3 | 1.1 | 1.4 | 1.5 |
| HV_CEb0020C01r2_at | 1.4 | 0.9 | 4.3 | 2.8 | 2.2 | 1.7 | 1.0 | 1.2 | 0.6 |
| Contig2550_x_at | 0.8 | 0.7 | 5.8 | 7.4 | 6.1 | 3.1 | 1.4 | 2.7 | 0.9 |
| Contig2211_at | 1.0 | 1.0 | 3.1 | 3.7 | 3.0 | 1.8 | 1.1 | 1.5 | 0.8 |

1. A method for increasing an inherent defense mechanism of a plant comprising using at least one chloronicotinyl of the formula (I), 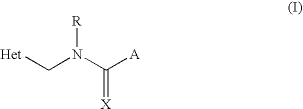
wherein
Het represents a heterocycle which is in each case optionally mono- or polysubstituted by fluorine, chlorine, methyl or ethyl and is selected from the following group of heterocycles:
pyrid-3-yl, pyrid-5-yl, 3-pyridinio, 1-oxido-5-pyridinio, 1-oxido-5-pyridinio, tetrahydrofuran-3-yl and thiazol-5-yl,
A represents C₁-C₆-alkyl, —N(R¹)(R²) or S(R²),
wherein
R¹ represents hydrogen, C₁-C₆-alkyl, phenyl-C₁-C₄-alkyl, C₃-C₆-cycloalkyl, C₂-C₆-alkenyl or C₂-C₆-alkinyl, and
R² represents C₁-C₆-alkyl, C₂-C₆-alkenyl, C₂-C₆-alkinyl, —C(═O)—CH₃ or benzyl,
R represents hydrogen, C₁-C₆-alkyl, C₂-C₆-alkenyl, C₂-C₆-alkinyl, —C(═O)—CH₃ or benzyl or, together with R², represents one of the following groups:
—CH₂—CH₂—, —CH₂—CH₂—CH₂—, —CH₂—O—CH₂—, —CH₂—S—CH₂—, —CH₂—NH—CH₂— and —CH₂—N(CH₃)—CH₂—, and
X represents N—NO₂, N—CN or CH—NO₂,
optionally in combination with one or more additional plant protection active compounds.

2. A method according to claim 1, wherein the chloronicotinyl is at least one selected from the group consisting of imidacloprid, clothianidine, dinotefuran, thiamethoxam, thiacloprid, aetamiprid and nitenpyram.

3. A method according to claim 2, wherein the chloronicotinyl is imidacloprid.

4. A method according to claim 1, wherein the plant is transgenic.

5. A method according to claim 1 for protecting a plant against biotic stress factors.

6. A method of inducing PR proteins in a plant comprising:
treating the plant with a chlornicotinyl of the formula (I), 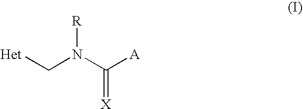
in which
Het represents a heterocycle which is in each case optionally mono- or polysubstituted by fluorine, chlorine, methyl or ethyl and is selected from the following group of heterocycles:
pyrid-3-yl, pyrid-5-yl, 3-pyridinio, 1-oxido-5-pyridinio, 1-oxido-5-pyridinio, tetrahydrofuran-3-yl and thiazol-5-yl,
A represents C₁-C₆-alkyl, —N(R¹)(R²) or S(R²),
wherein
R¹ represents hydrogen, C₁-C₆-alkyl, phenyl-C₁-C₄-alkyl, C₃-C₆-cycloalkyl, C₂-C₆-alkenyl or C₂-C₆-alkinyl and
R² represents C₁-C₆-alkyl, C₂-C₆-alkenyl, C₂-C₆-alkinyl, —C(═O)—CH₃ or benzyl,
R represents hydrogen, C₁-C₆-alkyl, C₂-C₆-alkenyl, C₂-C₆-alkinyl, —C(═O)—CH₃ or benzyl or, together with R², represents one of the following groups:
—CH₂—CH₂—, —CH₂—CH₂—CH₂—, —CH₂—O—CH₂—, —CH₂—S—CH₂—, —CH₂—NH—CH₂—, —CH₂—N(CH₃)—CH₂— and
X represents N—NO₂, N—CN or CH—NO₂,
optionally in combination with one or more additional plant protection active compounds.

7. Method according to claim 6, wherein the chloronicotinyl comprises imidacloprid,
clothianidine, dinotefuran, thiamethoxam, thiacloprid, acetamiprid and/or nitenpyram.

8. Method according to claim 7, wherein the chlornicotinyl is imidacloprid.

9. Method according to claim 6, the plant is at least one of barley, tobacco, tomatoes, wheat, corn, rice, soya, cotton, rape, potatoes, brassicas, paprika, aubergines, cucumber, lettuce, melons, turf, citrus, vines, coffee, tea, hops, pomaceous fruit, stone fruit and/or soft fruit.

10. Method of protecting a plant from infestation by at least one of fungal, bacterial or viral pathogens by treating said plant with a chloronicotinyl.

11. Method according to claim 10, wherein the plants is treated with imidacloprid.

12. A plant that has been protected against damage from at least one of fungal, bacterial or viral pathogens, said plant comprising from 0.00001% to 0.05% of at least one chloronicotinyl.

13. A plant according to claim 12, wherein the chloronicotinyl comprises imidacloprid, clothianidine, dinotefuran, thiamethoxam, thiacloprid, acetamiprid and/or nitenpyram.

14. A plant according to claim 12, wherein the chloronicotinyl is imidacloprid.

15. A plant according to claim 14, wherein the protection against damage from fungal, bacterial or viral pathogens is obtained by the induction of PR proteins.

16. A method of claim 10, wherein the chloronicotinyl comprises imidacloprid, clothianidine, dinotefuran, thiamethoxam, thiacloprid, acetamiprid and/or nitenpyram.

17. A method according to claim 10, wherein the chloronicotinyl comprises imidacloprid.

18. A method according to claim 10, wherein the plant is protected against damage from fungal, bacterial or viral pathogens by the induction of PR proteins.

19. A method for increasing the expression of genes from a PR protein comprising applying a treatment comprising at least one chloronicotinyl.

20. A method of claim 19 wherein said treatment is applied to a plant.
